(19) United States
(12) Patent Application Publication
(10) Pub. No.: US 2008/0168910 A1
(43) Pub. Date: Jul. 17, 2008

(54) Press and method of controlling the press

(76) Inventors: Hartmut Dexling, Goppingen (DE); Martin Schmeink, Salach (DE); Matthias Bruckner, Esslingen (DE); Andreas Dangelmayr, Ottenbach (DE); Rainer Hauff, Goppingen (DE)

Correspondence Address: RONALD S. LOMBARD;PATENTS AND TRADEMARKS, 4430 TWIN OAKS DRIVE, MURRYSVILLE, PA, 15668, US

(21) Appl. No.: 12/008,055

(22) Filed: Jan. 8, 2008

(30) Foreign Application Priority Data
Jan. 17, 2007 (DE) 10 2007 003 335.6

(51) Int. Cl. B30B 15/26; B30B 13/00; B30B 1/00

(52) U.S. Cl. 100/35; 100/214

(57) ABSTRACT

An arrangement and a method for the programming of presses is described. The programming is performed interactively by an input of points on a display screen, wherein the points determine the movement strategy x′ (α). For calculating the resulting plunger-time curve or plunger-guide angle-curve, preferably a Fourier analysis or, respectively Fourier transformation and back transformation of the curve determined by the input values is performed. In this way, a smooth and well executed kinematics plunger movement is obtained.

### CROSS-REFERENCE TO RELATED APPLICATION

This application claims the priority benefits of German Application No. 10 2007 003 335.6 filed Jan. 17, 2007.

### BACKGROUND OF THE INVENTION

The invention relates to a press, particularly a drawing press and to a method of controlling the press

Increasingly, presses whose plungers are driven by one or several servomotors are placed in use. By corresponding programming of the servomotor control, various desired movement strategies of the plunger can be realized as a “movement strategy”, in this case, the position x of the plunger depending on the time t or a so-called guide angle α is to be understood. The guide angle, for example, is the angle of a drive shaft of a press which is running in the same rhythm and is arranged ahead, or after, the press and through which the same workpiece is moved. The guide angle may also be a synthetically generated angle which repeatedly moves from zero to 360°, for example in a time-proportional manner.

The programming of press drives may be difficult for an operator, particularly if the relationship between the rotation of the servomotor and the movement of the plunger is not linear. This is the case, if the drive structure between the servomotor and the plunger is an eccentric drive, an elbow drive or a similar drive linkage.

Based hereon, it is the object of the invention to facilitate the programming of the press for an operator

### SUMMARY OF THE INVENTION

An arrangement and a method for the programming of presses is described. The programming is performed interactively by an input of points on a display screen, wherein the points determine the movement strategy x′ (α). For calculating the resulting plunger-time curve or plunger-guide angle-curve, preferably a Fourier analysis or, respectively Fourier transformation and back transformation of the curve determined by the input values is performed. In this way, a smooth and well executed kinematics plunger movement is obtained.

The press according to the invention includes one or several servomotors and a plunger which are interconnected by a drive arrangement. The drive arrangement is preferably a linkage drive. It is preferably a linkage drive with a small number of drive members. The linkage drive has a force transmission behavior which provides for high dynamic rigidity near the lower dead center of the plunger.

In accordance with the invention, part of the press is a control arrangement which facilitates the input of a desired movement strategy for the plunger in a simple way. To this end the control arrangement includes a representation module which displays on a screen the travel/time curve or travel/guide angle curve that is that movement strategy which applies to the plunger when the servomotor runs at constant speed. This screen representation can be changed by the operator in an interactive way for which different possibilities can be provided. It is, for example, possible to show on the curves displayed on the screen selected points whose position on the screen can be changed. For moving these points, for example, input arrays may be provided in which the x- α-positions of the selected points are indicated. These arrays may be in the form of input arrays wherein a change of the indicated universal values results in a displacement of the points on the screen. It is also possible to omit such input arrays and to move the points on the screen, for example, by suitable positioning means, such as a mouse, a track ball or cursor keys. It is also possible to combine both input and representation possibilities, for example, by recording the input points moved by the mouse, the joy stick, the track ball or similar means and indicate their new coordinates x and α in corresponding arrays. These points which can be changed by input means represent so to say “magic” points. The calculation module calculates the new movement strategy in each case in such a way that it extends through these magic points. In this way, the speed of the servomotor is modulated. The modulation may include standstill phases or one or several reversals of the direction of rotation of the servomotor.

It is possible to operate with predetermined magic points, right from the start, which based on the predetermined movement strategy assume predetermined positions and are present in a predetermined member. It is, however, also possible to give the operator the option to remove or add magic points. This can occur, for example, by the click of the mouse. Furthermore, an option may be provided for the operator to move magic points on the curve of the given movement strategy. Also, the operating screen surface may first be without any magic points and the operator may then introduce magic points onto the movement strategy and move them thereon. The maximum number of magic points may be limited, if desired. The magic points are preferably indicated on the displayed movement strategy in order to indicate clearly to the operator which points he has determined as mandated points, that is points which must not be by-passed. The calculation module then can calculate the movement strategy of the plunger substantially free of restraints based on the predetermined magic points. Herein a movement strategy is preferred wherein the plunger is subjected to the least possible acceleration or deceleration processes. But it is also possible to post other optimizing criteria. An optimizing criterion may be, for example, the maximum power occurring at the servomotor. Alternatively, the maximum current may be the limit. Or, alternatively, a maximum current-time-product may be used as an optimization limit—or criterion, in order to prevent overheating of the servomotor or its control components.

The displacement of the magic points may be limited to the x direction. However, a possibility may be provided for the operator to move one or several of the magic points alternatively or additionally in the α direction.

Preferably, the calculation module calculates the movement strategy determined by the magic points on the basis of a number of trigonometric functions whose frequencies are in an integral relationship to one another. Generally, a predetermined low number of trigonometric functions, for example four, five, six, seven or eight, should be sufficient for the recalibration of most of the desired movement strategies.

The invention consequently provides an input technique whereby, based on a predetermined bias kinematics, for example, a dashed line is shown on the input screen which, based on the time or a guide angle extends from the upper dead point, that is, fixed point, via the lower dead point back to the upper dead point, that is, fixed point. By distorting the curve on the screen or by moving the position of the upper dead point the line shown on the screen can be displaced. It is sufficient in this connection, if the line is represented only by a few points. It may show first specific corners, that is, it may look like a polygon approximation. In addition, an input maybe provided which generates on the base kinematics a number of points which can then be moved individually or in groups, for example, vertically. The movement of the points in vertical and/or horizontal direction, the distortion of the shown movement strategy by clicking at individual points and moving them or by the input of changed x and/or α values in corresponding input arrays provides for edition possibilities. With all edition possibilities for the points, it is continuously monitored that the points do not leave an acceptable value range and that the continuous series of points in horizontal directions is maintained. In addition, also limitations in vertical direction with regard to continuity are monitored. It is possible to provide a software module which indicates the acceptable value range on the screen in the form of a range or a band.

With the programming possibilities presented above, means are provided for the operator to establish in a simple way complicated movement strategies with simple base kinematics for linkage drives with a small number of drive members. This substantially facilitates the operation.

Further, details of advantageous embodiments of the invention are apparent from the accompanying drawings. The drawings disclose additional features and are to be considered by the person skilled in the art. The drawings show a particular embodiment of the invention.

### BRIEF DESCRIPTION OF THE DRAWINGS

FIG. 1 is a press and a control arrangement in a schematic representation;

FIG. 2 is a block diagram of the control arrangement for the press of FIG. 1;

FIG. 3 is a screen image of the control arrangement showing the base-kinematics;

FIG. 4 is a screen image with various points edited for a new kinematics;

FIG. 5 is a screen image showing a basic kinematics and a changed kinematics;

FIG. 6 is the screen showing a changed kinematics; and,

FIG. 7 schematically shows various program modules for editing or movement strategy of a press plunger.

### DESCRIPTION OF THE PREFERRED EMBODIMENTS

FIG. 1 shows a press which may be, for example, a drawing press 1 which has a drive arrangement 2 including at least one servomotor 3, which is connected to a press plunger 5 by way of a transmission 4. The plunger 5 carries a movable tool part 6 with which a stationary tool part 7 is associated. The transmission 4 is in the form of a linkage drive. In the present case, it is an elbow lever drive.

The, at least one, servomotor 3 is controlled by a control arrangement 8 which comprises an image screen 9 and an input means 10, for example, in the form of a keyboard 11 and a positioning device 12. The positioning device 12 may be a joystick, a track ball, a light pin, a touch pad or a similar device. Also cursor keys may be used for the positioning of the objects shown on the screen 9.

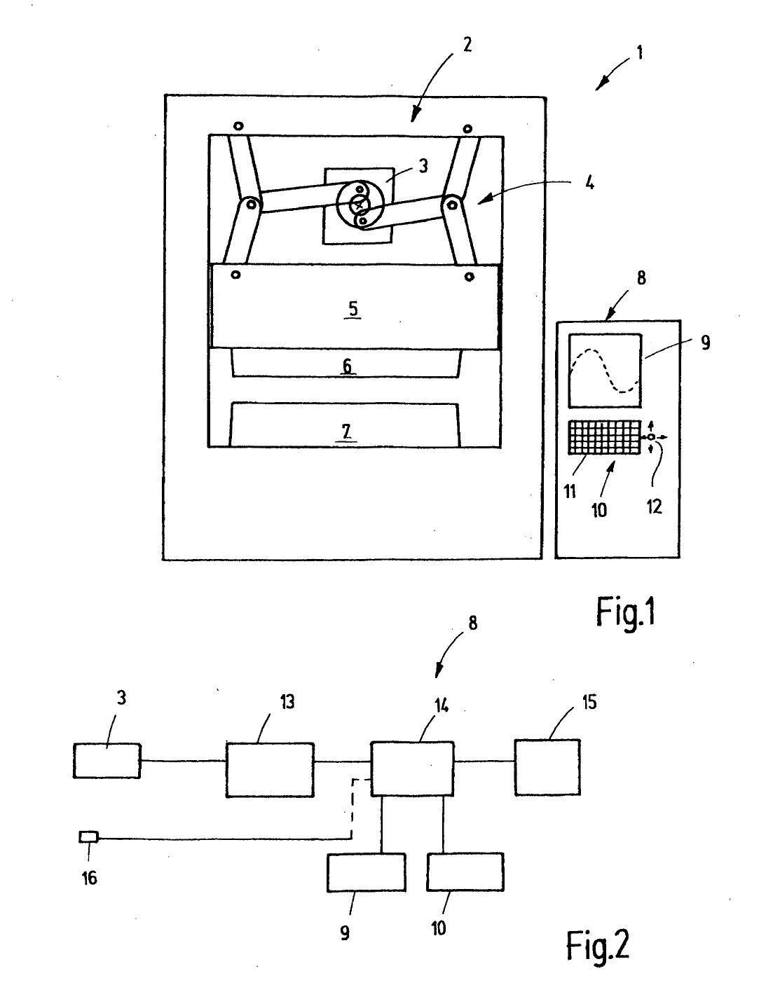

FIG. 2 shows the basic structure of the control arrangement 8. It includes at least the servomotor 3, power electronics 13 necessary for controlling the motor, a processing unit 14, for example in the form of a computer including a storage device 15 as well as the image screen 9 and an input device 10. The processing unit 14 may be connected to a sensor 16 which monitors the angular position of the servomotor 13 or also the position of the plunger 5. If necessary, also the processing unit 14 may be connected, via a transmission line which is not shown, to a guide angle generator which generates a synthetic guide angle. Alternatively, the processing unit 14 may be connected to another press which provides a press operating tact or rhythm or receives it from the processing unit 14. A signal arriving from another connected press may also be used as a synthetic guide angle. In the most simple case, the guide angle is purely time-proportional.

The processing unit 14 operates several software modules. The modules may comprise separate programs, program parts, program libraries or program sections. Herein, the term “module” is used for any type of program—or software—technical unit which fulfills the functions referred to below.

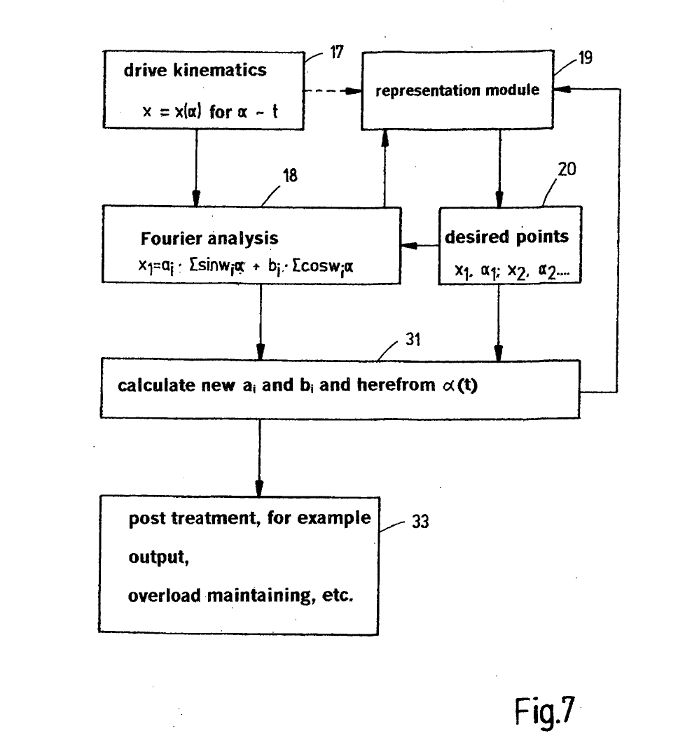

On the basis of the kinematics of the transmission 4, there is a fixed mechanical relationship between the rotational angle α of the servomotor 3 and the movement or position x of the plunger 5. This fixed relationship is called drive kinematics x=x(α). A first module 17 represents this relationship as shown in FIG. 7. This can occur, for example, by a calculation or a selection from a stored list or a table. The drive kinematics module 17 is, for example, connected to an analysis module 18 which submits the predetermined drive kinematics to a Fourier analysis. The analysis module 18, in this connection, determines Fourier coefficients aᵢ, bᵢ, for frequencies ωᵢ which summarized, provide the drive kinematics x (α).

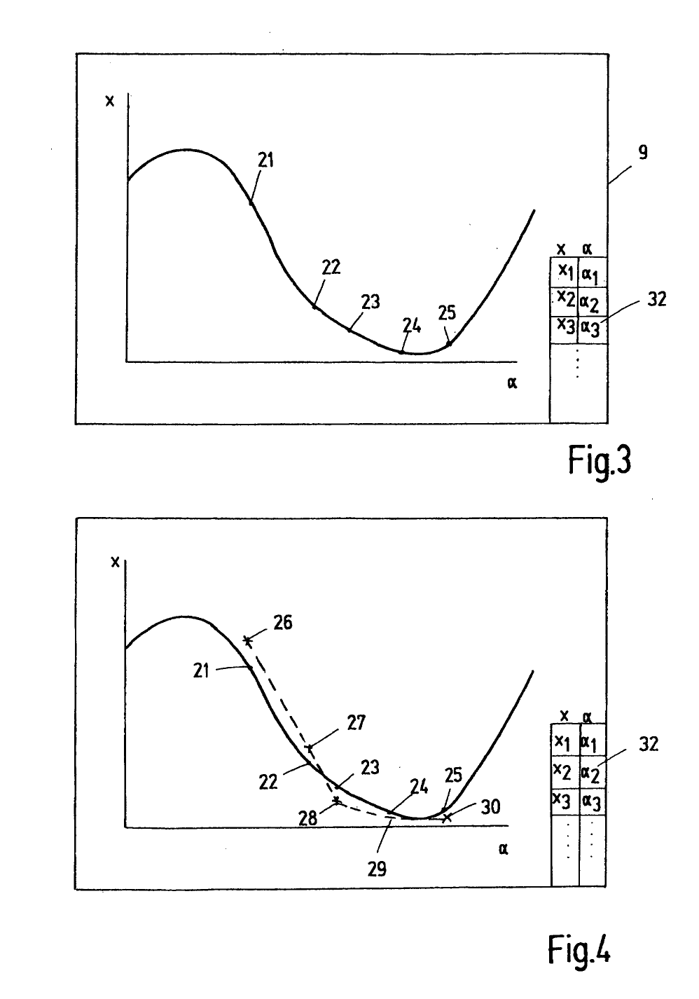

Furthermore, a display representation module 19 is provided which obtains the data to be displayed either from the drive kinematics module 17 or from the analysis module 18. It displays, on the display screen, the drive kinematics x (α) as shown in FIG. 3. The display screen 9 is further connected to an input module 20 which is itself connected to the input device 10. The input module 20 then permits a change of the movement strategy shown in FIG. 3. This may be achieved, for example, by the influence of certain points, 21, 22, 23, 24, 25, which are present on the movement strategy of FIG. 3 or can be determined thereon. With a comfortable software variant, the points 21 to 25 are freely selectable as for their numbers and also their positions are concerned. With a somewhat more limited software variant, the number of the points 21-25 is predetermined. In an even further limited variant, at least the angular positions a of the points 21 to 25 are predetermined.

The operator may now change the points 21 to 25, for example, by means of the input device 10. The change is noted by the input module 20. The change can be made by inputting function values into an input table 32, which are displayed on the display screen 9. With a more comfortable software variant, the inputs can be provided alternatively or additionally by moving the points 21 to 25 on the display screen 9. In a presently preferred variant, the points 21 to 25 can be moved only vertically, that is in x direction. With a more comfortable software variant, the points are freely movable, that is they can also be moved in the α-direction.

FIG. 4 shows the input state wherein the points 21 to 25 have been moved to different vertical or, respectively, x positions. The resulting points 26 to 30 can be shown isolated or interconnected by a curve. Preferably, they are interconnected by way of a polygon line. This line may be shown in a different color or by dashed lines or it may be exhibited in another emphasizing way.

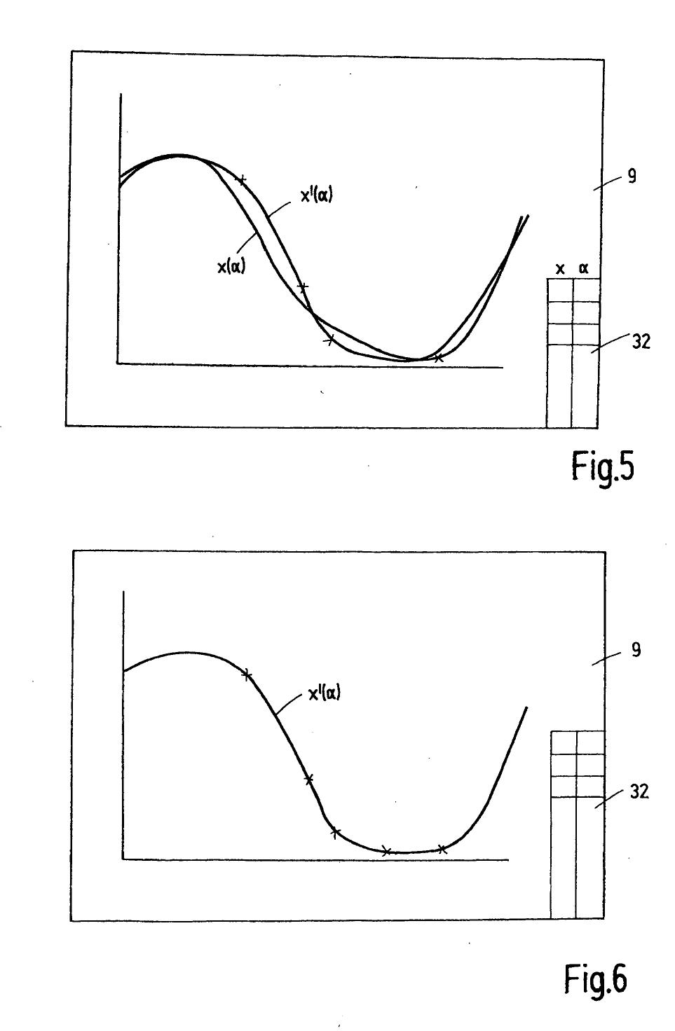

The input module 20 then transfers the point values to a calculation module 31 and/or the analysis module 18. It is pointed out that the analysis module and the calculation module 31 may be combined in a single module which would then be called calculation module. The calculation module 31 includes the Fourier coefficients aᵢ, bᵢ, for the movement strategy x (α) for the uniformly rotating servomotor 3. The calculation module 31 also includes stored therein the Fourier coefficients for a movement strategy x′ (α) which is obtained by the changed magic points 26 to 30. The calculation module 31 can then calculate from the different Fourier coefficients the speed modulations which the servomotor 3 has to undergo in order to establish the new movement strategy x′ (α). The calculation module 31 utilizes for the determination of the desired movement strategy (sin ωₒα, cos ωₒα) of the plunger 5 a sum of trigonometric functions (sin ωᵢα, cos ωᵢα). Preferably, the calculation module 31 uses trigonometric functions (sin ωᵢα, cos ωᵢα) which have frequencies (ωᵢ) which have a whole number relationship to the frequency (w₀) of a trigonometric function (sin ωₒα, cos ωₒα) which has the lowest frequency. The calculation module 31, preferably examines whether the realization of the desired movement strategy x′ (α) of the plunger 5 load limit values are exceeded. If the load limit values are exceeded the calculation module 31 increases the time t for a press stroke. Also, the calculation module may reduce the lowest frequency (w₀) when the load limit is exceeded. Both movement strategies x (α) and x′ (α) can be shown on the display screen 9 as presented in FIG. 5. This again, is achieved by the representation module 19. In addition, the data can be transmitted to an output module 33 which processes the data for the actual control of the servomotor 3, that is, which converts them to desired current and/or voltage values or, respectively desired position values.

As shown in FIG. 6, an output type may be selected whereby only the newly changed movement strategy x′ (α) is shown on the display screen. However, this can be changed by proceeding as described above.

It is pointed out, that FIG. 7 represents a software structure not a process diagram. The representation of the software structure is limited in this connection to essential aspects. It can also be replaced by another software structure which, on the basis of another approximation of the movement strategy, results in a similar equivalent or the same functionality. The analysis module 18 and the calculation module 31, however, prefer functions which are suitable for a continuous differentiation. Furthermore, the output module 33 may include a maintaining routine which examines the established new movement strategy x′ (α) for the loading of the drive 2, particularly, the servomotor 3. There may be a correction routine which, in case of overload, initiates a slow-down of the overall movement of the plunger 5, that is a reduction of the stroke number until the movement strategy x′ (α) is in an acceptable range for each angle- and time point.

Above, an arrangement and a method for the programming of presses has been described. The programming occurs interactively by the input of points on a display screen, wherein the points determine a movement strategy x′ (α). For calculating the resulting plunger-time curve or the plunger-guide angle curve, preferably a Fourier analysis or, respectively, a Fourier transformation and back transformation of the curve determined by the input values is performed. In this way, a smooth and well executed harmonic plunger movement is obtained.

What is claimed is:

1. A press (1), particularly a drawing press, comprising a plunger (5) supporting a movable tool part (6), at least one servomotor (3) for driving the plunger (5), a transmission (4) for a drive connection of the servomotor (3) to the plunger (5), a control arrangement (8) comprising a data processing unit (14), a data storage unit (15), an input device (10) and a display screen (9), a representation module (19) for establishing a predetermined movement strategy (x (α)) of the plunger (5) by means of the display screen (9), an input module (20) for providing points (26-30) for defining the movement strategy (x′ (α)) of the plunger (5), a calculation module (31) for calculating control signals required for achieving the desired movement strategy (x′ α) of the plunger (5) and for representing the resulting movement strategy (x′ (α)) of the plunger (5) on the display screen (9), an output module (33) for processing data for the actual control of the at least one servomotor (3).

2. A press according to claim 1, wherein the transmission (4) provides for a non-linear connection between the rotation of the servomotor (3) and the movement of the plunger (5).

3. A press according to claim 1, wherein the transmission (4) is a linkage drive.

4. A press according to claim 1, wherein the predetermined movement strategy (x (a)) of the plunger (5) represents a functional connection between the time t or a guide angle α and the resulting position x of the plunger (5) if the servomotor (3) runs at constant speed.

5. A press according to claim 1, wherein for the establishment of the points (26-30) these points can be positioned on the display screen (9) by means of the input device (10).

6. A press according to claim 1, wherein the calculation module (31) determines from the established points (26-30) on the basis of the function which can be continuously differentiated a kinematic function for the movement of the plunger (5) and for the rotation of the servomotor (3).

7. A press according to claim 1, wherein the calculation module (31) utilizes for the determination of the desired movement strategy (x′ (α)) of the plunger (5) a sum of trigonometric functions (sin ωᵢα, cos ωᵢα).

8. A press according to claim 1, wherein the calculation module (31) uses trigonometric functions (sin ωᵢα, cos ωᵢα) have frequencies (ωᵢ) which have a whole number relationship to the frequency (ωₒ) of a trigonometric function (sin ωₒα, cos ωₒα) which has the lowest frequency.

9. A press according to claim 1, wherein the calculation module (31) examines whether with the realization of the desired movement strategy (x′ (α)) of the plunger (5) load limit values are exceeded.

10. A press according to claim 9, wherein the calculation module (31) increases the time t for a press stroke when the load limit values are exceeded.

11. A press according to claim 8, wherein the calculation module (31) reduces the lowest frequency (ωₒ) when the load limit is exceeded.

12. A method for establishing a movement strategy for a plunger (5) of a press (1), particularly a drawing press, which includes the plunger (5) for supporting a movable tool part (6), at least one servomotor (3) for driving the plunger (5), a transmission (4) for a drive connection of the servomotor (3) with the plunger (5), and a control arrangement (8) with a processing unit (14), a data storage device (15), an input device (10), an output module (33) and a display screen (9), said method comprising by means of the display device (9) first points (21-25) of a movement strategy (x (α)) for the plunger (5) are shown, then new points (26-30) are provided in accordance with a changed movement strategy for the plunger (5) the movement strategy (x′(α)) of the plunger (5) is calculated so that it includes the new points 26-30), and the resulting movement strategy (x′ (α)) of the plunger (5) is displayed by the display screen (9).

13. A method according to claim 12, wherein first the movement strategy (x (α)) of the plunger is displayed.

14. A method according to claim 12, wherein the input of the desired points (26-30) occurs by moving the original points (21-25).

15. The method according to claim 12, wherein the input of the desired values (26-30) occurs by inputting values of the plunger positions (xᵢ) with respect to corresponding angle positions (αᵢ).

16. The method according to claim 12, wherein the movement strategy (x′ (α)) of the plunger (5) is provided in the form of points determined by Fourier calculation from a sum of trigonometric functions.
